(19) United States
(12) Patent Application Publication
(10) Pub. No.: US 2003/0116885 A1
(43) Pub. Date: Jun. 26, 2003

(54) Method and apparatus to deform a plastic rivet

(76) Inventors: Claude Lessard, Levis (CA); Laurier Mercier, Saint-Damien de Buckland (CA)

Correspondence Address: ERIC B. MEYERTONS, MEYERTONS, HOOD, KIVLIN, KOWERT & GOETZEL, P.C., P.O. BOX 398, AUSTIN, TX, 78767-0398, US

(21) Appl. No.: 10/324,223

(22) Filed: Dec. 20, 2002

Related U.S. Application Data
(60) Provisional application No. 60/341,215, filed on Dec. 20, 2001.

(51) Int. Cl. B29C 65/44

(52) U.S. Cl. 264/249; 425/508; 425/500; 425/392

(57) ABSTRACT

An apparatus and a method to deform a plastic rivet is described herein. The apparatus comprises a generally tubular outer wall configured and sized to enclose the rivet to be deformed and a piston slidably mounted in the generally tubular outer wall for longitudinal movements between a rest position and a pressure applying position. The deformation of the plastic rivet occurs when said piston moves towards the pressure applying position.

### FIELD OF THE INVENTION

The present invention relates to rivets. More specifically, the present invention is concerned with a method and apparatus to deform plastic rivets.

### BACKGROUND OF THE INVENTION

Rivets are well known in the art. They are usually made of metallic material and are inserted in corresponding apertures of two elements to be secured together while hot and then deformed to permanently join the two elements.

Variations on this theme have been designed over the years. For example, many rivets are now made of thin metallic material that can be deformed while they are at room temperature.

Plastic rivets are also known in the art. For example, U.S. Pat. No. 4,478,544 issued on Oct. 23, 1984 and entitled “Composite Rivet” describes a composite rivet similar to a conventional blind rivet.

Tools used to deform plastic rivets may also be found in the art. For example. U.S. Pat. No. 4,736,507 issued on Apr. 12, 1988 and entitled “Tool for setting plastic rivets” describes such a tool.

### OBJECTS OF THE INVENTION

An object of the present invention is therefore to provide an improved method and apparatus to deform a plastic rivet.

### SUMMARY OF THE INVENTION

More specifically, in accordance with an aspect of the present invention, there is provided an apparatus to deform a plastic rivet; said apparatus comprising:

a generally tubular outer wall configured and sized to enclose the rivet to be deformed;

a piston slidably mounted in said generally tubular outer wall for longitudinal movements between a rest position and a pressure applying position;

wherein deformation of the plastic rivet occurs when said piston moves towards said pressure applying position.

According to another aspect of the present invention, there is provided a method for deforming a plastic rivet comprising the acts of:

enclosing a deformable portion of the rivet with a generally cylindrical outer wall;

applying pressure on an end of the rivet with a piston slidably movably mounted in the outer wall.

Other objects, advantages and features of the present invention will become more apparent upon reading of the following nonrestrictive description of preferred embodiments thereof, given by way of example only with reference to the accompanying drawings.

### BRIEF DESCRIPTION OF THE DRAWINGS

In the appended drawings:

FIG. 1 is a sectional view of a plastic rivet according to a first embodiment of the present invention shown prior to its deformation; FIG. 1 also shows a portion of an apparatus to deform the plastic rivet;

FIG. 2 is a sectional view showing the plastic rivet of FIG. 1 during its deformation;

FIG. 3 is a sectional view of the rivet of FIG. 1, fully deformed;

FIG. 4 is a perspective view of a portion of an apparatus used to deform a plastic rivet;

FIG. 5 is a sectional view similar to FIG. 1 but illustrating a plastic rivet according to a second embodiment of the present invention;

FIG. 6 is a sectional view showing the plastic rivet of FIG. 5 during its deformation; and

FIG. 7 is a sectional view of the rivet of FIG. 5, fully deformed.

### DESCRIPTION OF THE PREFERRED EMBODIMENT

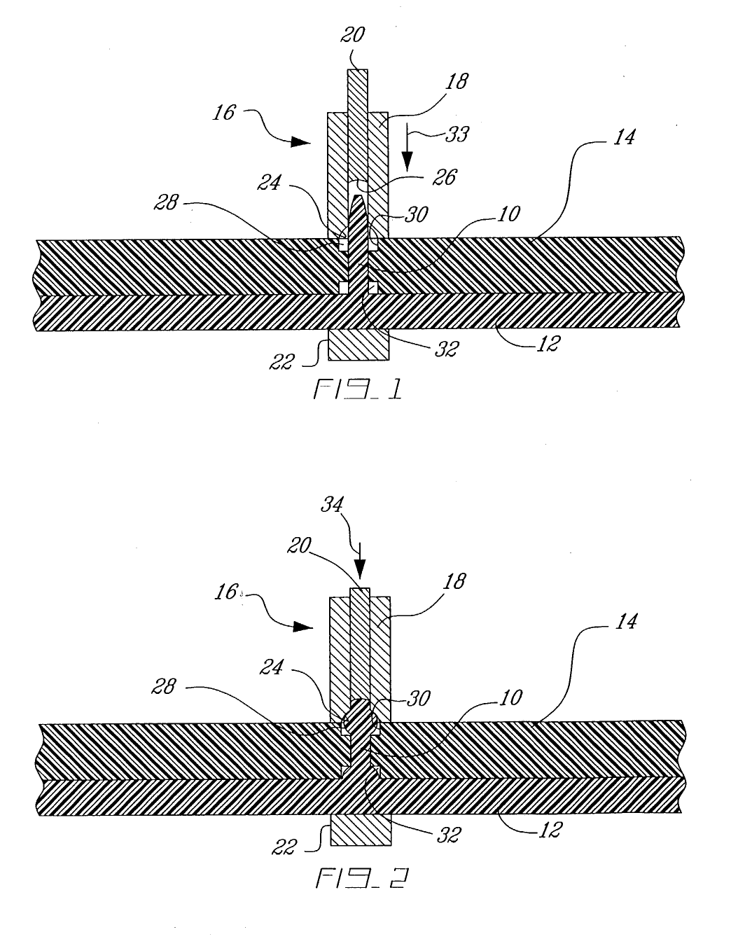

Turning now to FIG. 1, a plastic rivet 10 according to a first aspect of the present invention will be described.

The rivet 10 is part of a plastic plate 12 to which a second plastic plate 14 is to be permanently secured.

The goal is to permanently deform the rivet 10 to therefore permanently secure the two plates 12 and 14.

This is done with an apparatus 16 partly shown in FIG. 1. This apparatus includes a generally tubular outer wall 18, a deforming piston 20 and, optionally, a compression resistant surface 22 positioned opposite the outer wall 18. Indeed, as will be understood by one skilled in the art, a compression resistant surface is required but need not be part of the apparatus 16.

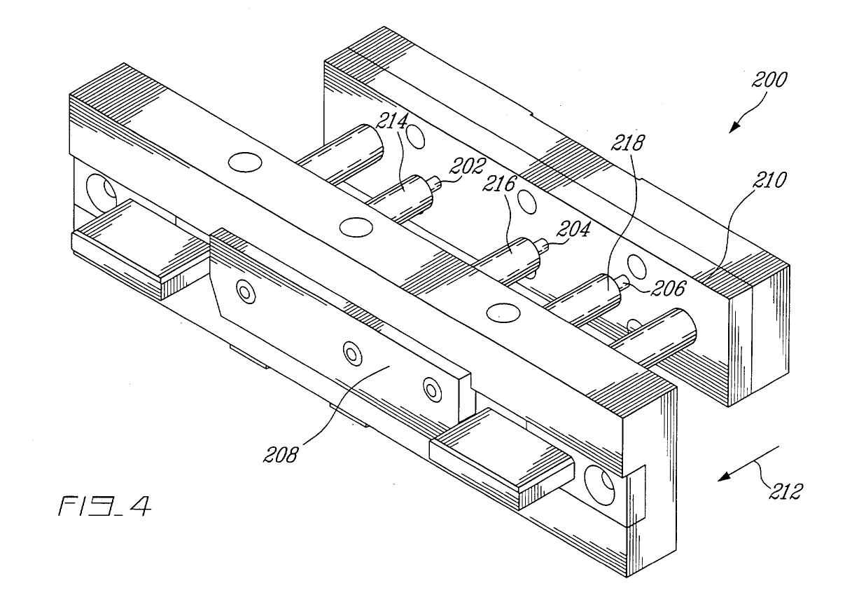

The outer wall 18 includes a generally rounded shoulder 24 and the deforming surface 26 of the piston 20 is also generally rounded at the same radius as the shoulders to yield a semi-spherical surface once the piston 20 is in its fully compressing position (shown in FIG. 3).

The surface 22 is generally flat and, if the apparatus 16 is in the form of pliers, may be hingeably mounted thereto. As will be described hereinbelow, the function of the surface 22 is to oppose the pressure generated by the movements of the piston during the deformation of the rivet 10.

Indeed, one skilled in the art will easily understand that an interesting form of the apparatus 16 consists in pliers. Advantageously, these pliers (not shown) would be so designed that the movement of the outer wall 18 towards the compression resistant surface 22 would occur before the movement of the piston 20 towards this same surface 22. Of course, depending on the size of the rivet to be deformed, force multiplication schemes, such as, for example, ratcheting could be used.

Returning to FIG. 1, it is to be noted that the aperture 28 includes a double rectangular shoulder (30 and 32). It is also to be noted that the portion of the rivet 10 exceeding the plate 14 has a volume that is generally equal to the sum of the volumes of the shoulders 30 and 32, the rounded shoulders 24 and the concavity of the deforming surface 26.

The deformation of the rivet 10 will now be described with reference to FIGS. 1 to 3.

The first step in the deformation of the rivet 10 is illustrated in FIG. 1. His first step generally consists in moving the outer wall 18 in the direction of arrow 33 so that it encloses the rivet 10 while being in contact with the plate 14 while the surface 22 is in contact with the plate 12, thereby firmly pressing the two plates 12 and 14 against each other.

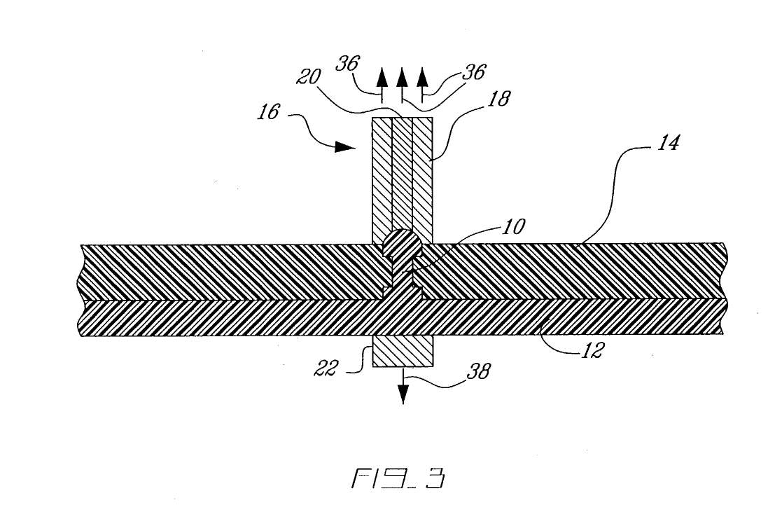

FIG. 2 illustrates the second step in the deformation of the rivet 10. This step consists in physically deforming the rivet. More specifically, FIG. 2 illustrates the beginning of the deformation of the rivet 10 by the downward pressure of the piston 20 (see arrow 34). As can be seen in this Figure, the portion of the rivet 10 exceeding the plate 14 is gradually deformed to fill the shoulders 24, 30 and 32. It is to be noted that during this step, the outer wall 18 does not move.

Once the deformation is complete (see FIG. 3), the apparatus 16 used to deform the rivet 10 may be removed (see arrows 36 and 38) to leave the two plates 12 and 14 permanently attached.

It is to be noted that depending on the type of plastic used to form the rivet 10, it is possible to design an apparatus 16 where the piston 20 will move a little further than the position illustrated in FIG. 3 so that when the pressure is relieved, the spring back of the head of the rivet will form the spherical shape illustrated in FIG. 3.

It is to be noted that the shoulders 30 and 32 are not required.

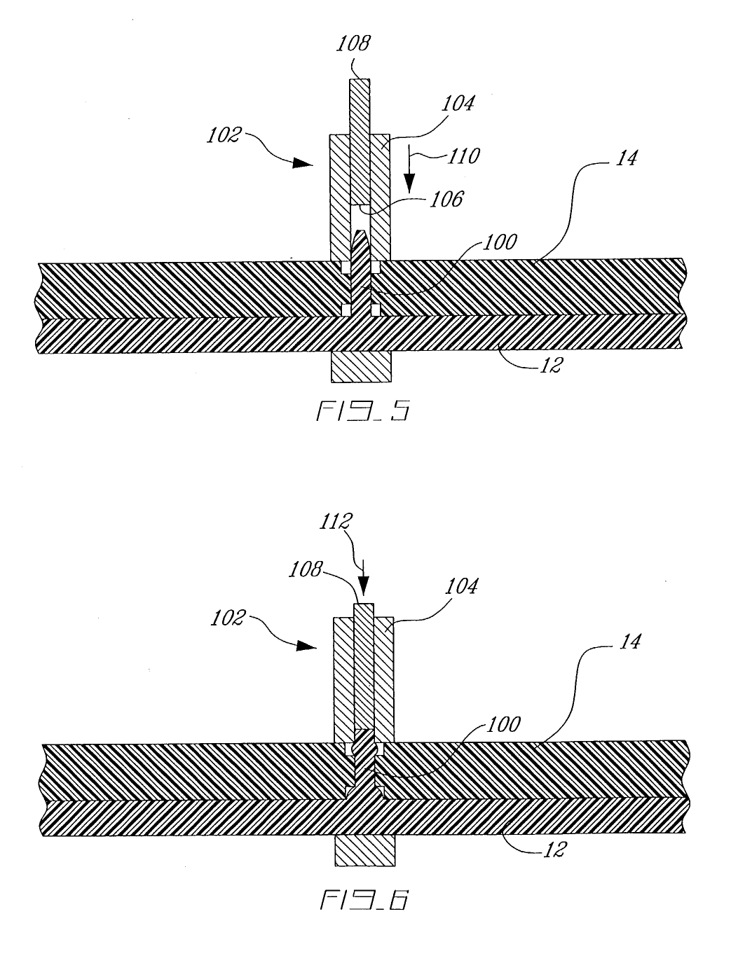

Turning now briefly to FIGS. 5 to 7 of the appended drawings, a rivet 100 according to another embodiment of the present invention will be described. Since the rivet 100 is very similar to the rivet 10 illustrates in FIGS. 1 to 3 only the differences between these rivets will be described hereinbelow.

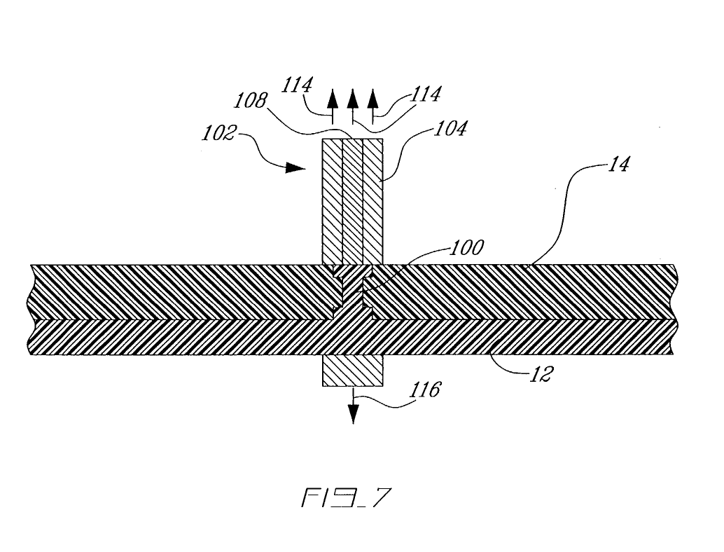

As can be seen from FIG. 6, the main difference between the rivet 100 and the rivet 10 is the size. Indeed, the rivet 100 is not intended to have a semi-spherical head once deformed but is intended to be flat with the surface of the plate 14.

To achieve this flat deformation, the apparatus 102 has an outer wall 104 having flat shoulders and the deforming surface 106 of the piston 108 is also flat.

Again, the deformation of the rivet 100 is done in the same steps as described hereinabove. The pre-deformation step is illustrated in FIG. 5 (see arrow 110), the deformation step is illustrated in FIG. 6 (see arrow 112) and the post deformation step is illustrated in FIG. 7 (see arrows 114 and 116).

As will easily be understood by one skilled in the art, depending on the kind of plastic used to form the rivets 10 and 100, the deformation may be done when the rivet is cold or warm.

Turning now to FIG. 4 of the appended drawings, a pressure-applying portion 200 of an apparatus to deform plastic rivets will briefly be described.

The portion 200 is designed to be mounted to a press-type machine to rivet three rivets at the same time. Of course, one skilled in the art will understand that more or less than three rivets could be deformed simultaneously.

This portion includes a front element 208, three tubular outer walls 214, 216 and 218, three pistons 202, 204 and 206 longitudinally slidable in a respective tubular outer wall, and a rear element 210 configured to apply pressure on the protruding ends of the pistons 202, 204 and 206.

In operation, the front element 208 is positioned against the pieces to be joined (not shown but corresponding to the plate 14 of FIGS. 1 to 3) and then the rear element 210 is moved in the direction of arrow 212 to contact the protruding ends of the pistons 202, 204 and 206, that are slidably mounted in respective tubular outer walls 214, 216 and 218, to cause the pressure applying ends of the pistons to contact the rivets (not shown). The deformation of the three rivets is then done as described hereinabove.

As will easily be understood by one skilled in the art, other apparatuses to deform plastic rivets could be designed.

One skilled in the art, will understand that by enclosing the rivet to be deformed prior or at the beginning of the pressure applying step of the piston, the final shape of the deformed rivet is more predictable.

It is to be noted that even though the appended figures all illustrate a plastic rivet that is integral with one of the plates, the above-described apparatus and method are not limited to that kind of rivet but would also be advantageous with rivets that are separate from both plates and where the plates are both provided with apertures.

Although the present invention has been described hereinabove by way of preferred embodiments thereof, it can be modified, without departing from the spirit and nature of the subject invention as defined in the appended claims.

What is claimed is:

1. An apparatus to deform a plastic rivet; said apparatus comprising:
a generally tubular outer wall configured and sized to enclose the rivet to be deformed;
a piston slidably mounted in said generally tubular outer wall for longitudinal movements between a rest position and a pressure-applying position;
wherein deformation of the plastic rivet occurs when said piston moves towards said pressure applying position.

2. The apparatus described in claim 1, further comprising a compression resistant surface positioned opposite said generally tubular outer wall so as to oppose the pressure generated by the movements of said piston.

3. The apparatus described in claim 2, wherein said apparatus is in the form of pliers.

4. The apparatus described in claim 3, wherein said apparatus includes a force multiplication mechanism.

5. The apparatus described in claim 1, wherein said apparatus is intended to be mounted to a press-type machine, said apparatus comprising a front element supporting at least one generally tubular wall and a rear element configured and sized to contact and apply pressure onto a protruding end of at least one piston.

6. The apparatus described in claim 1, wherein said generally tubular outer wall has generally rounded shoulders and wherein said piston has a generally rounded pressure applying surface so as to yield a generally semispherical deformed rivet head.

7. A method for deforming a plastic rivet comprising the acts of:
enclosing a deformable portion of the rivet with a generally cylindrical outer wall;
applying pressure on an end of the rivet with a piston slidably movably mounted in the outer wall.
